(19) United States
(12) Patent Application Publication
(10) Pub. No.: US 2013/0189059 A1
(43) Pub. Date: Jul. 25, 2013

(54) TRANSFORMING TRAILER

(71) Applicants: Bobby Hall, Columbia, SC (US); Jerry S. Hall, Prosperity, SC (US); Kevin Haney, Hartsville, SC (US); Johnny Newsome, Hartsville, SC (US)

(72) Inventors: Bobby Hall, Columbia, SC (US); Jerry S. Hall, Prosperity, SC (US); Kevin Haney, Hartsville, SC (US); Johnny Newsome, Hartsville, SC (US)

(73) Assignee: Sonoco Development Incorporated, Hartsville, SC (US)

(21) Appl. No.: 13/355,679

(22) Filed: Jan. 23, 2012

(51) Int. Cl. B60P 1/26

(52) U.S. Cl. 414/480; 414/812

(57) ABSTRACT

The present invention relates to a transforming trailer that may include extension legs that allow the trailer to transform between loading and hauling positions. The trailer may include a foldable loading platform that allows for ease of loading when the trailer is in the loading position but that folds when the transforming trailer is in a hauling position.

### FIELD OF THE INVENTION

The present invention relates generally to trailers to be pulled by motor vehicles. More particularly, the present invention relates to a trailer that can be transformed into a ramp for depositing material onto the trailer bed.

### BACKGROUND OF THE INVENTION

Motor vehicle trailers have been, and continue to be, utilized in a number of applications. In some instances, they may provide space, apart from the available area of the motor vehicle, to allow a user to transport materials. Efforts have been made to adapt motor vehicle trailers to particular applications.

### SUMMARY OF THE INVENTION

According to an aspect, the present invention provides a transforming trailer that includes a trailer having a body defining a first trailer end and a second trailer end. The transforming trailer further includes a leg proximate the first trailer end including an outer casing connected to the trailer body and extending downward and a leg extension located within the outer casing such that the leg extension may move between an extended position, with the leg extension in contact with aground surface, and a retracted position, with the leg extension above the ground surface. In addition, movement of the leg extension into an extended position causes the trailer body to move into a loading position, with the first trailer end raised and the second trailer end lowered so that the trailer body slopes downwardly from the first trailer end to the second trailer end, and movement of the leg support into a retracted position causes the trailer body to move into a hauling position, with the trailer body relatively parallel to the ground surface. The transforming trailer also includes a foldable loading platform located proximate the second trailer end and defining an upper platform surface and a lower platform surface. The foldable loading platform includes a first platform portion and a second platform portion both having an upper surface and a lower surface, where the first platform portion is positioned nearer the first trailer end than the second platform portion and where the first platform portion and the second platform portion are hinged together. The transforming trailer also includes a platform hydraulic cylinder connected to the upper surface of the first platform portion and to the trailer body for raising the foldable loading platform to the hauling position in which the first platform portion is relatively perpendicular to the trailer body, and wherein the second platform portion is folded and positioned relatively perpendicular to the trailer body.

According to another aspect, the present invention also provides a transforming trailer capable of being pulled by a standard pickup truck or van, and the transforming trailer includes a trailer having a body defining a first trailer end and a second trailer end. The transforming trailer further includes a leg proximate the first trailer end that includes an outer casing connected to the trailer body and extending downward, a leg extension located within the outer casing, and a telescoping leg hydraulic cylinder located within the outer casing. Actuation of telescoping leg hydraulic cylinder moves leg extension between an extended position, with the leg extension in contact with a ground surface, and a retracted position, with the leg extension above the ground surface. In addition, movement of the leg extension into an extended position causes the trailer body to move into a loading position, with the first trailer end raised and the second trailer end lowered so that the trailer body slopes downwardly from the first trailer end to the second trailer end. Movement of the leg extension into a retracted position causes the trailer body to move into a hauling position, with the trailer body relatively parallel to the ground surface.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a side view of a transforming trailer in accordance with a first embodiment of the present invention where the leg extension is in a retracted position;

FIG. 2 is a side view of the transforming trailer of FIG. 1 where the leg extension is in an extended position;

FIG. 3 is a side view of the transforming trailer of FIG. 1 where the leg support is in an extended position;

FIG. 4 is a side view of the transforming trailer of FIG. 1 where the foldable loading platform is partially in an extended position;

FIG. 5 is a side view of the transforming trailer of FIG. 1 in the loading position;

FIG. 6 is an enlarged side view of transforming trailer first trailer end of FIG. 1;

FIG. 7 is an enlarged side view of transforming trailer first trailer end of FIG. 1 where the leg extension is in an extended position;

FIG. 8 is an enlarged side view of transforming trailer first trailer end of FIG. 1 where support leg is in an extended position;

FIG. 9 is a side view of a transforming trailer in accordance with a second embodiment of the present invention; and

FIG. 10 is a side view of the transforming trailer of FIG. 9 where the transforming trailer is in the loading position.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

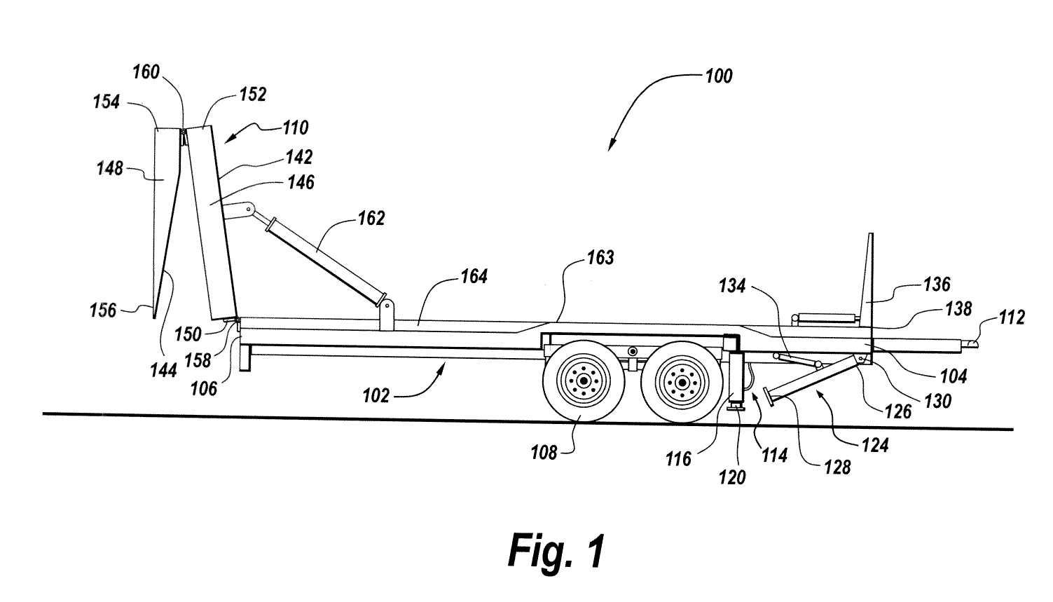

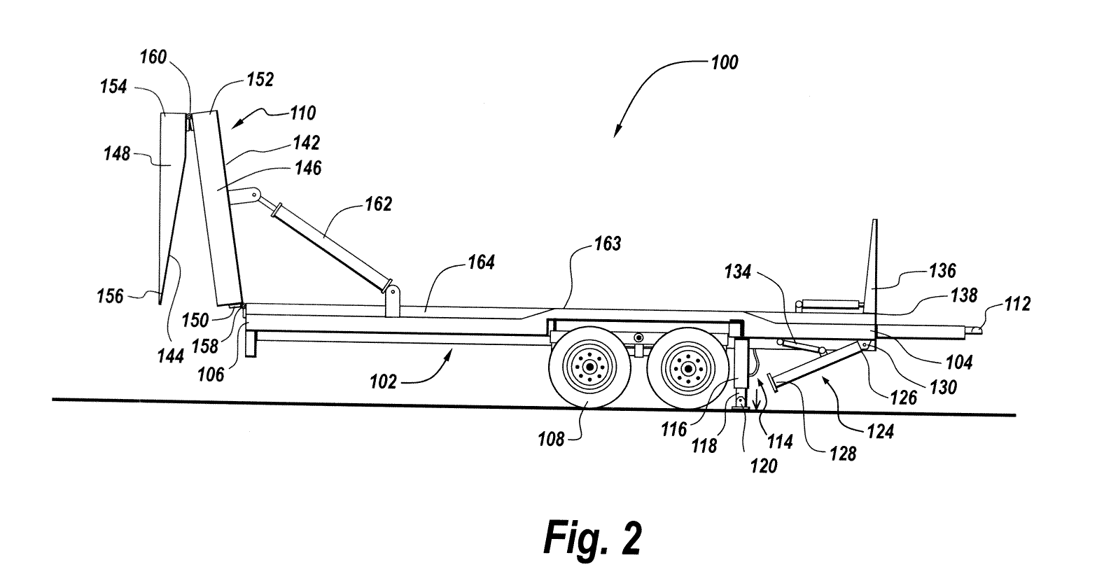

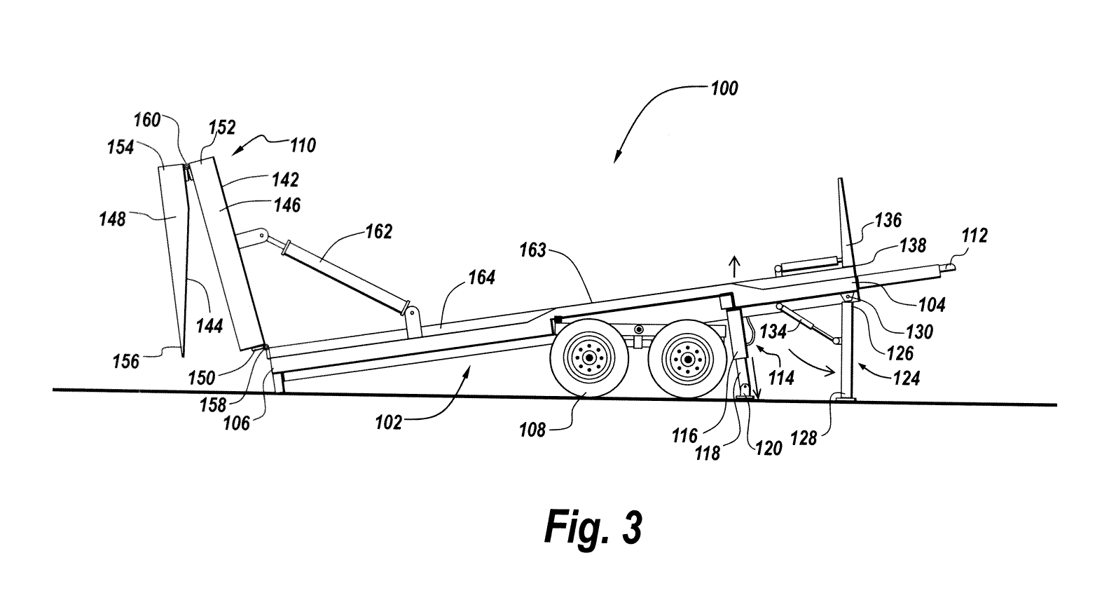

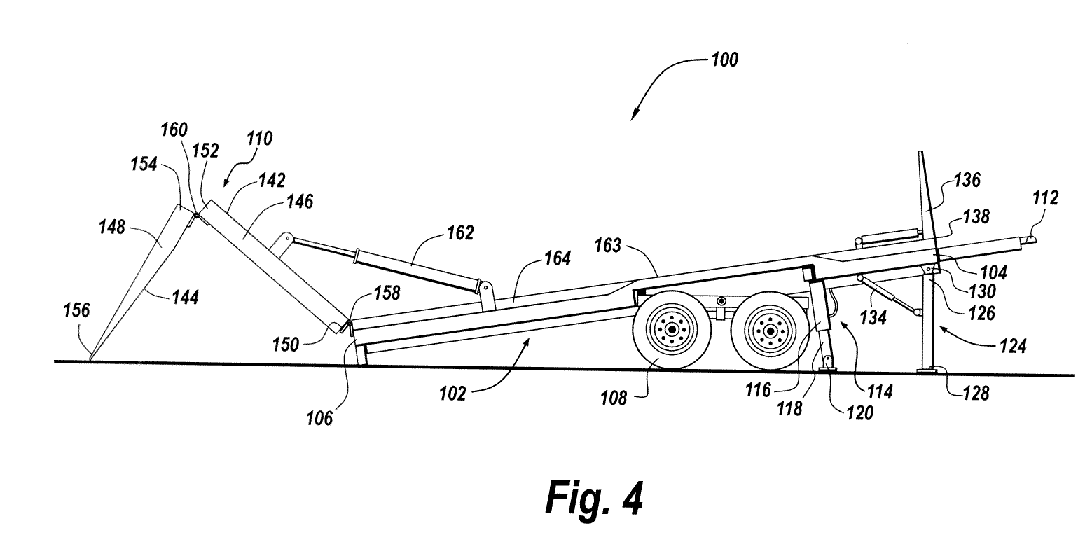

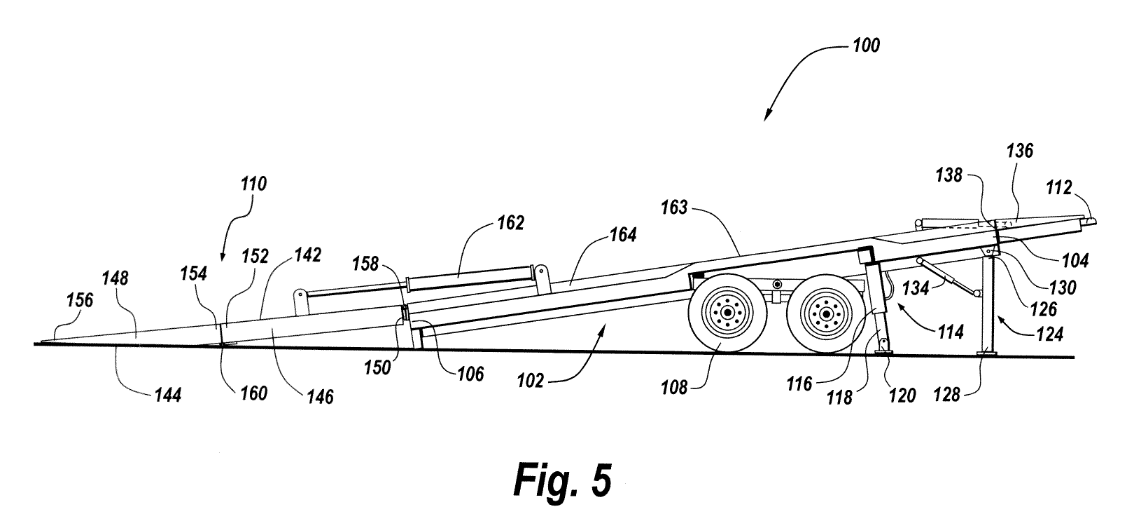

A transforming trailer 100 in accordance with an embodiment of the present invention is shown in the FIGS. 1-5. Transforming trailer 100 includes, among other items, a trailer body 102 that extends between a first trailer end 104 and a second trailer end 106, wheels 108 to aid in the transportation of transforming trailer 100, and a foldable platform 110. As more clearly shown in FIGS. 1 and 5, transforming trailer 100 may transition between a hauling position, where trailer body 102 is substantially parallel to the ground surface, and a loading position, where trailer body 102 is at an angled orientation.

Transforming trailer 100 further includes a connector 112 located at first trailer end 104 such that transforming trailer 100 may be pulled by a motor vehicle. In some embodiments, connector 112 may include a standard trailer coupler to connect to a standard trailer hitch and ball located on a motor vehicle. In other embodiments, couplers utilized with tractor-trailers may be used. For example, connector 112 may include a coupling pin to attach to a fifth wheel coupling device of a towing truck. The user's application of transforming trailer will dictate the necessary connector utilized.

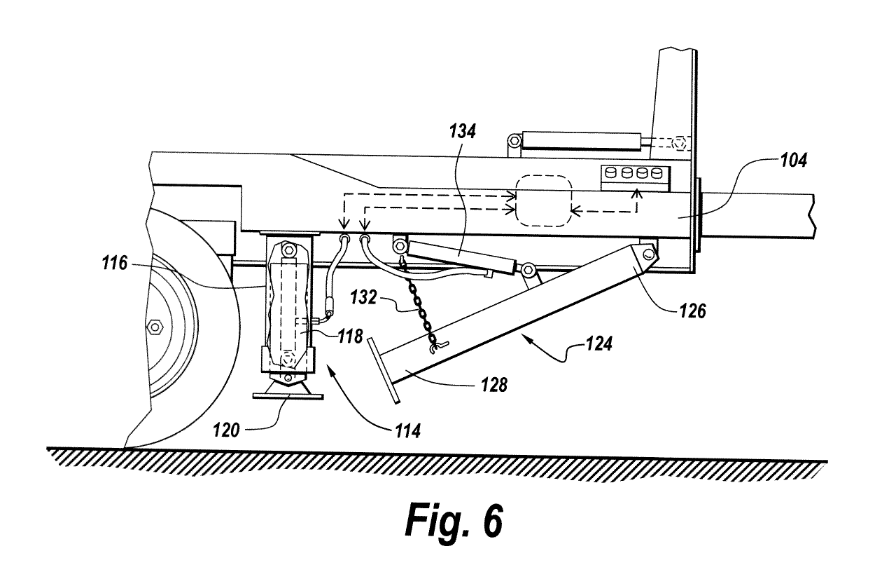

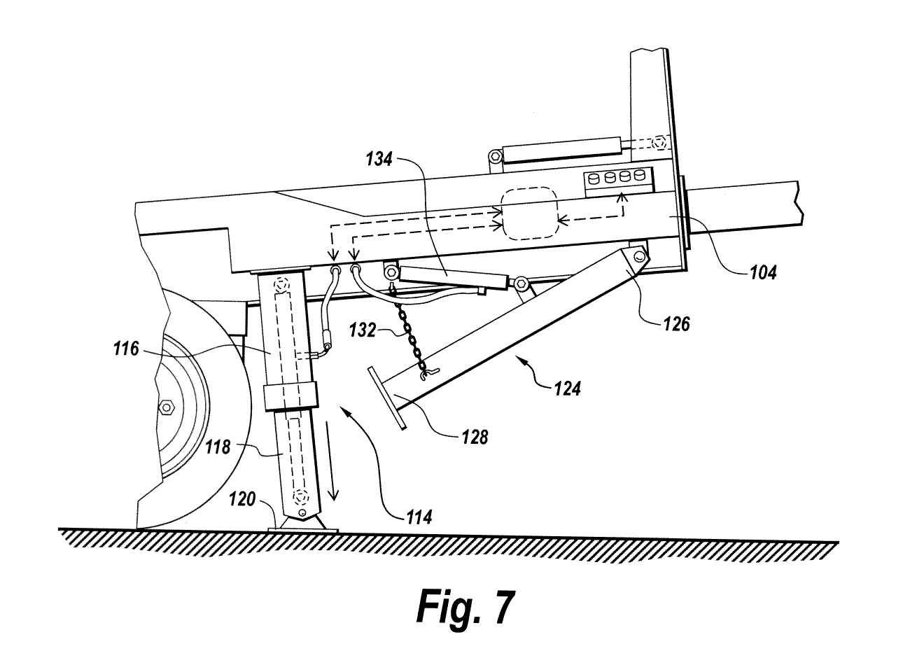

Transforming trailer 100 includes one or more telescoping legs 114 for aiding in the transformation of transforming trailer 100 between the hauling position and the loading position. As explained below, it will be understood that telescoping leg 114 may be of sufficient size to operate as a single unitary leg or may be two or more individual legs spaced apart across all or a portion of the width of trailer body 102. Telescoping legs 114 are located proximate first trailer end 104 and underneath trailer body 102. Each telescoping leg includes an outer casing 116 that extends in a downward direction and is substantially hollow and a leg extension 118 located within outer casing 116. As more clearly shown in FIGS. 6 and 7, leg extension 118 may move between a retracted position (FIG. 6), where leg extension 118 is further within outer casing, and an extended position (FIG. 7), where the leg extension makes contact with the ground surface. In some embodiments, leg extension 118 may include a support foot 120 for aiding in the leg extension's contact with and angle to the ground surface.

In some embodiments, transforming trailer 100 may further include a telescoping leg hydraulic cylinder 122 located within outer casing 116. In embodiments where a telescoping leg hydraulic cylinder 111 is utilized, it may be connected and in mechanical communication with leg extension 118. The communication between telescoping leg hydraulic cylinder 122 and leg extension 118 may be such that activation of telescoping leg hydraulic cylinder 122 may move leg extension 118 between its retracted position and extended position.

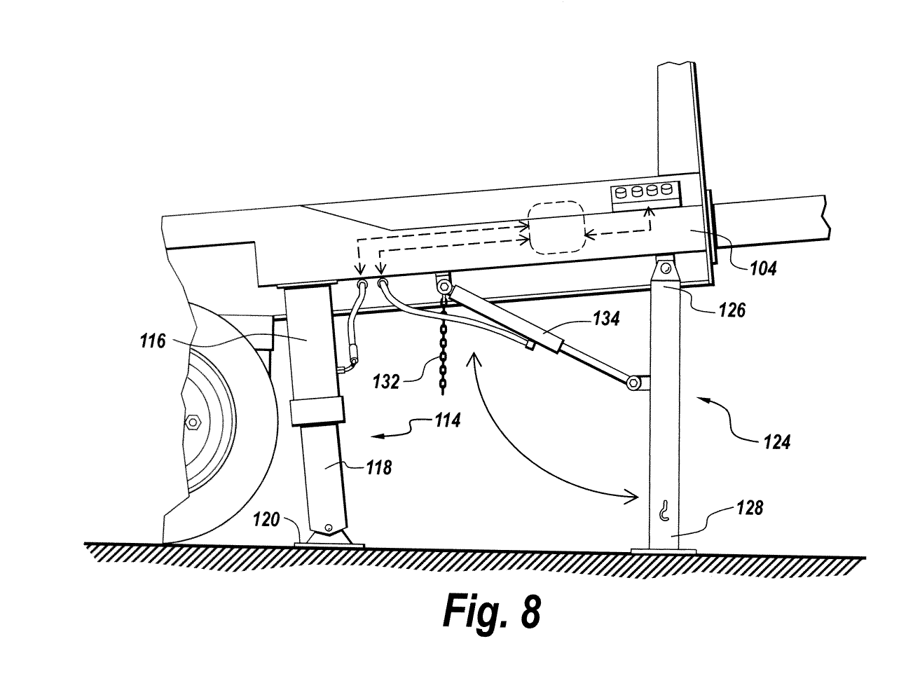

As shown with respect to the first embodiment, transforming trailer 100 may further include support leg 124, where support leg 124 defines a first end 126 and a second end 128. Support leg 124 may provide additional support to ensure that transforming trailer 100 maintains its configuration in the loading position when desired. Support leg first end 126 may be connected to a hinge 130 located underneath trailer body 102 such that support leg 124 may move between a retracted position (FIG. 7), where support leg second end 128 is above the ground surface, and an extended position (FIG. 8), where support leg second end 128 makes contact with the ground surface.

When support leg 124 is in a retracted position, support leg second end 128 may be connected to trailer body to further ensure support leg 124 does not transition to the extended position at an undesired time. Although FIG. 6 illustrates the connection of support leg second end 128 to trailer body 102 with the use of a chain 132, other connectors known in the art may also be utilized. For example, rope or other fasteners may be used.

Support leg 124 may further be connected to a support leg hydraulic cylinder 134 intermediate support leg first end 126 and second end 128. Support leg hydraulic cylinder 134 is also located underneath trailer body 102 and is in mechanical communication with support leg 124. Based on such communication, activation of support leg hydraulic cylinder 134 may move support leg 124, in connection with support leg hinge 130, between the retracted position and the extended position as shown in FIGS. 7 and 8.

The number of telescoping legs 114 and support legs 124 utilized with transforming trailer 100 may vary based on the user's specifications and/or according to loading/hauling demands. For example, in some embodiments, transforming trailer 100 may include two telescoping legs and two support legs, or a single support leg and two telescoping legs. The user may utilize any combination depending on the specifications of the use.

In additional embodiments and as shown in FIG. 1, transforming trailer 100 may include a trailer lip 136 located on first trailer end 104. Trailer lip 136 may aid in creating a flush surface between trailer body 102 and an additional structure, such as a tractor trailer bed and may provide additional trailer body space for carrying more materials. Trailer lip 136 is connected to trailer body 102 with a trailer lip hinge 138 such that trailer lip 136 may move between a retracted position (FIG. 1), where trailer lip 136 is substantially perpendicular to trailer body 102, and an extended position (FIG. 5), where trailer lip 136 may be substantially parallel to trailer body 102.

In an embodiment, transforming trailer may further include a trailer lip hydraulic cylinder 140 located on trailer body 102 and connected to trailer lip 136. Trailer lip hydraulic cylinder 140 may further be in mechanical communication with trailer lip 136 such that activation of trailer lip hydraulic cylinder 140 may move trailer lip 136, in connection with trailer lip hinge 138, between its retracted position and its extended position.

As indicated above, transforming trailer 100 further includes a foldable loading platform 110. Foldable loading platform 110 is located proximate second trailer end 106 and defines an upper platform section 142, a lower platform section 144, a first platform portion 146 and a second platform portion 148. Both first platform portion 146 and second platform portion 148 include first ends 150, 154 and second ends 152, 156. First platform portion 146 is closer to trailer body 102 than second platform portion 148 and connects to trailer body 102 at first platform portion first end 150. First platform portion 146 further connects to second platform portion first end 154 on first platform portion second end 152. The connection of each end 150, 152 of first platform portion 146 to the corresponding item may be accomplished with hinges 158, 160 or other movable connecting or hinged devices.

First platform portion 146 may be further connected to a platform hydraulic cylinder 162 intermediate first platform portion first end 150 and second end 152. As shown in the embodiment illustrated in FIGS. 1-5, platform hydraulic cylinder 162 may be located on an upper surface 163 of trailer body 102. As further shown in FIGS. 1-5, platform hydraulic cylinder 162 may be located in a recess 164 of trailer body 102.

Platform hydraulic cylinder 162 is in mechanical communication with first platform portion 146 such that activation of platform hydraulic cylinder 162 may move foldable loading platform 110 between a retracted position (FIG. 1) and an extended position (FIG. 5). In foldable loading platform retracted position (FIG. 1), both first platform portion 146 and second platform portion 148 are relativey perpendicular to trailer body 102. In contrast, in foldable loading platform extended position (FIG. 5), both first platform portion 146 and second platform portion 148 are substantially in-line with trailer body 102.

The number of platform hydraulic cylinders 162 utilized with transforming trailer 100 may vary based on the user's specifications and needs. For example, in some embodiments, transforming trailer 100 may include two platform hydraulic cylinders 162, one on either side of trailer body 102. In other embodiments, only one platform hydraulic cylinder 162 may be utilized. The user's specifications will dictate the number of platform hydraulic cylinders used.

In some embodiments, upper platform section 142 may include a non-skid surface. Such surface may include coatings of various anti-slip material, for example, paints or other coatings, or may include raised projections. Any non-skid material known in the art may be used.

In operation, transforming trailer 100 may transition between a hauling position and a loading position. When transforming trailer 100 is in a hauling position, it may be pulled by a motor vehicle to a desired location. In the hauling position, trailer body 102 is substantially parallel to the ground surface as shown in FIG. 1. In addition, the various components of transforming trailer are in a retracted position to ensure that they do not make contact with the ground surface where they would impede the transport of transforming trailer. For example, leg extensions 118, support legs 124, trailer lip 136, and foldable loading platform 110 are in the retracted position and away from contact of the ground surface. As explained above, each of the above-mentioned components' movement into the retracted position may be automated by the appropriate hydraulic cylinder(s) such that orienting transforming trailer into the hauling position may be done without manual action.

Once the desired location is reached, transforming trailer 100 may be transitioned from the hauling position to the loading position. When transforming trailer is in a loading position, it may be utilized, in some embodiments, to place material on trailer body 102 or to create a ramp from the ground surface. To transition transforming trailer 100 from the hauling position to the loading position, leg extensions 118 are actuated downward by telescoping leg hydraulic cylinder 122 until they reach the ground surface and start to raise first trailer end 104 by the continued downward force to leg extensions 118. As first trailer end 104 rises, second trailer end 106 lowers closer to the ground surface. In addition, actuation of first platform portion 146 by platform hydraulic cylinder 162 causes first platform portion 146 to extend outward until second platform portion second end 156 makes contact with the ground surface. As continued outward force is applied by platform hydraulic cylinder 162 second platform portion second end 156 moves along the ground surface, away from trailer body 102, until foldable loading platform 110 is substantially parallel and integral with trailer body 102. Wheels or the like may be mounted on the underside of second platform portion second end 156 to allow ease of travel across the ground surface during transformation. Also, if utilized, support legs 124 are transitioned to the extended position where support leg second end 128 may make contact with the ground surface due to the actuation of support leg hydraulic cylinder 134 in connection with support leg hinge 130. Once transforming trailer 100 has been transitioned into the loading position, trailer lip 136 may be moved to an extended position if desired by the user. The transition from the hauling position to the loading position is illustrated in FIGS. 1-5.

The angle of the ramp created structure when the transforming trailer 100 is in a loading position may be such to effectively allow the user to load and unload items from trailer body. For example, the angle may be such that a forklift truck is able to drive onto trailer body 102 without fear of it tipping over. In addition, the angle may be appropriate for materials to maintain their position on trailer body 102 while transforming trailer 100 is in the loading position. In some embodiments, in the loading position, transforming trailer 100 may be at an angle between 6° and 15°. In other embodiments, in the loading position, transforming trailer 100 may be at an angle between 8° and 10°. In further embodiments, transforming trailer 100 may have an angle of 9.8° in the loading position.

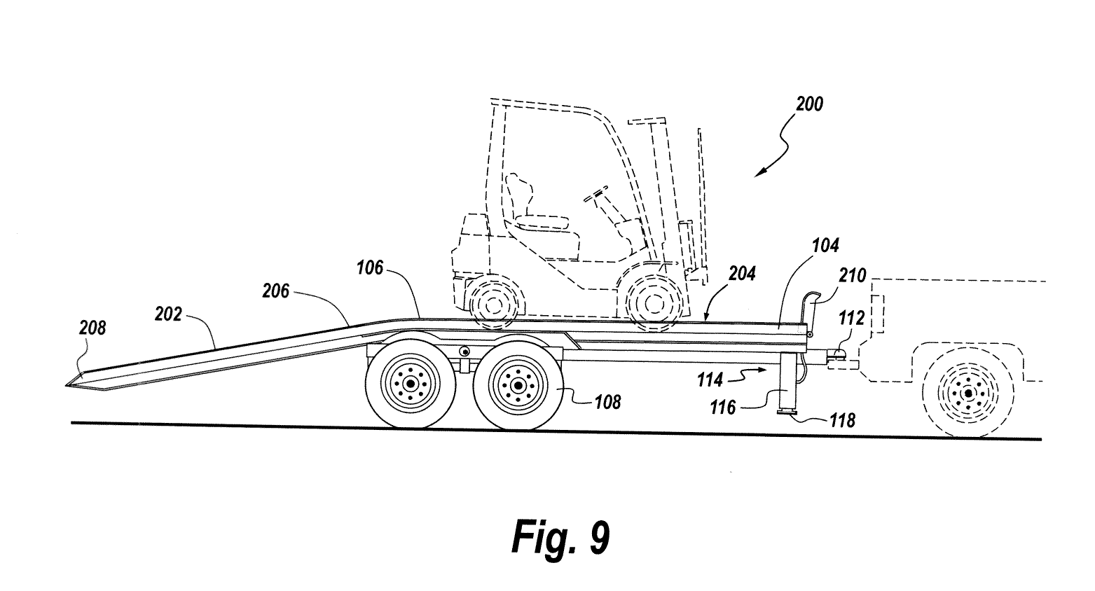

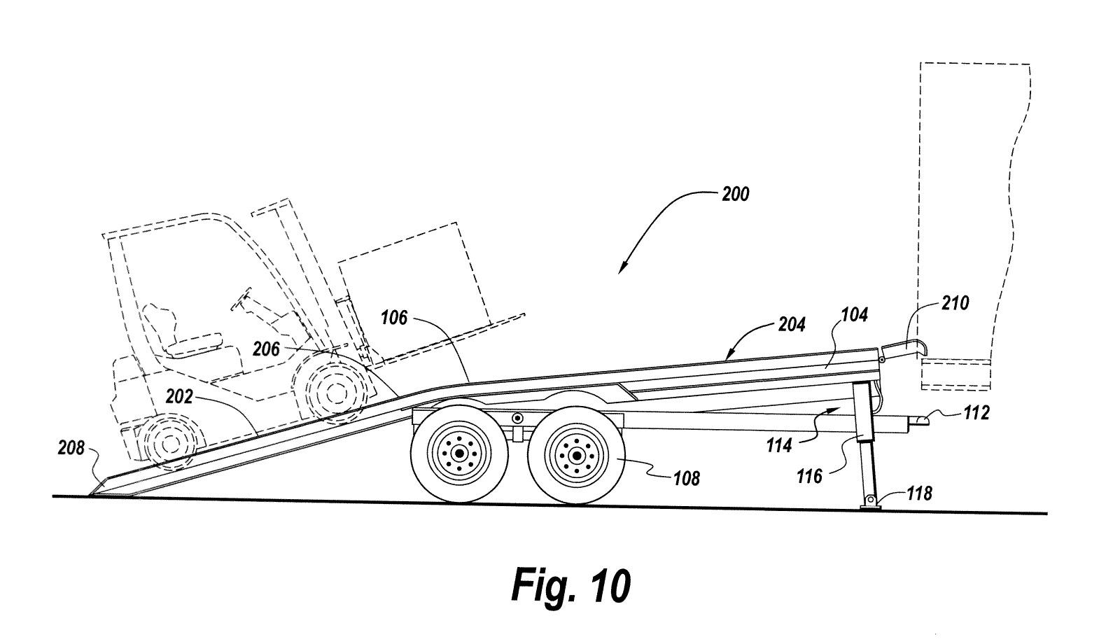

FIGS. 9 and 10 illustrate a second embodiment of transforming trailer 200. In the second embodiment, transforming trailer includes an angled platform 202 that is integral with, or ridgidly connected to, trailer body 204. As shown in the Figures, unlike the first described embodiment, angled platform 202 is constructed of a single piece that extends at a downward angle from a first end 206 connected to trailer body 204 to a second end 208. In addition, the second embodiment may or may not include support legs (not shown) as found in the first embodiment and may include a non-automated trailer lip 210, where movement of trailer lip 210 between a retracted position and an extended position is accomplished using manual force.

In operation, as with the first embodiment, transforming trailer 200 may transition between a hauling position and a loading position. In the hauling position, telescoping legs leg extensions 118 are retracted in outer casing 116 such that they do not make contact with the ground surface. As such, trailer body 204 is substantially in a parallel configuration to the ground surface and angled platform 202 does not make contact with the ground surface.

Once a desired loading location is reached, transforming trailer 200 may be transitioned to the loading position, where leg extensions 118 are actuated downward by telescoping leg hydraulic cylinder 122 until they reach the ground surface and start to raise first trailer end 104 by the continued downward force to leg extensions 118. As first trailer end 104 rises, second trailer end 106 lowers until angled platform second end 208 makes contact with the ground surface. It will be noted that, unlike the first embodiment, angled platform 202 is not substantially in-line with trailer body 204 when in the loading position. However, such configuration still allows for a user to effectively load and unload material. As further shown in FIG. 10, once transforming trailer has transitioned into the loading position, trailer lip 210 may be moved from a retracted position to an extended position to create a flush surface with an additional structure, for instance, the bed of a tractor trailer.

The various transforming trailers illustrated and disclosed above, and in which various components may be interchanged, allow for the effective and efficient collection and transport of materials. In addition, such tasks can be completed with little to no manual force on the part of the user.

In some embodiments, the present invention includes utilizing the above described transforming trailers in connection with standard pickup trucks or vans. As indicated above, connector 112 may be utilized to connect transforming trailer to any desired motor vehicle. In the embodiments where standard pickup trucks or vans are utilized, transforming trailer may be of an appropriate size in order to accommodate the towing capabilities of such motor vehicles. For example, in such embodiments, transforming trailer may have a weight limit between 12,000 and 18,000 lbs. In other such embodiments, transforming trailer may have a weight limit between 14,000 and 16,000 lbs. Advantageously, having transforming trailer meet the specifications required of a standard pickup truck or van allows for the use of transforming trailer without the need for the appropriate licenses that are applicable to transport with a tractor trailer.

As indicated above, the transforming trailers of the present invention allow for methods of effectively and efficiently collecting and transferring material utilizing the transforming trailer. Accordingly, the present invention contemplates the use of such methods. For example, the transforming trailer, in some embodiments, may be utilized to collect and transport baled materials or packaged materials. In such embodiments, transforming trailer may be of an appropriate size to accommodate a forklift trailer that would be transferred to the site of the material on the trailer body and would aid in the collection and placement of the material onto the trailer body once the desired loading location is reached and the transforming trailer has been transitioned into the loading position. In other embodiments, transforming trailer may be utilized to transport another vehicle, for instance, a car. As explained above, transforming trailer may create a ramp structure, when in the loading position, that allows for a vehicle to drive or to be pushed onto trailer body.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A transforming trailer comprising:
a trailer having a body defining a first trailer end and a second trailer end;
a leg proximate the first trailer end comprising:
an outer casing connected to the trailer body and extending downward;
a leg extension located within the outer casing such that the leg extension may move from an extended position, with the leg extension in contact with a ground surface, and a retracted position, with the leg extension above the ground surface;
wherein movement of the leg extension into an extended position causes the trailer body to move into a loading position, with the first trailer end raised and the second trailer end lowered so that the trailer body slopes downwardly from the first trailer end to the second trailer end, and
wherein movement of the leg support into a retracted position causes the trailer body to move into a hauling position, with the trailer body relatively parallel to the ground surface;
a foldable loading platform located proximate the second trailer end and defining an upper platform surface and a lower platform surface, the foldable loading platform comprising:
a first platform portion and a second platform portion both having an upper surface and a lower surface,
wherein the first platform portion is positioned nearer the first trailer end than the second platform portion and wherein the first platform portion and the second platform portion are hinged together; and
a platform hydraulic cylinder connected to the upper surface of the first platform portion and to the trailer body for raising the foldable loading platform to the hauling position in which the first platform portion is relatively perpendicular to the trailer body and positioned nearer the first trailer end than the second platform portion, and wherein the second platform portion is folded and positioned relatively perpendicular to the trailer body.

2. The transforming trailer of claim 2, wherein the leg proximate the first trailer end further includes a telescoping leg hydraulic cylinder located within the outer casing and in mechanical communication with the leg extension,
wherein actuation of the telescoping leg hydraulic cylinder may move leg extension from an extended position to a retracted position.

3. The transforming trailer of claim 1, wherein the transforming trailer includes a set of at least two legs proximate the first trailer end.

4. The transforming trailer of claim 1, wherein the transforming trailer further comprises a support leg comprising:
a first end connected to the trailer body by a support leg hinge, and
a second end;
wherein the second end may move from a position proximate the trailer body when transforming trailer is in the hauling position to a position in contact with the ground surface when transforming trailer is in the loading position.

5. The transforming trailer of claim 4, wherein a support leg hydraulic cylinder is connected to the trailer body at a first end of the support leg hydraulic cylinder and to the support leg at a second end of the support leg hydraulic cylinder, and
wherein actuation of the support leg hydraulic cylinder moves support leg second end from the position proximate the trailer body to the position in contact with the ground surface.

6. The transforming trailer of claim 4, wherein the transforming trailer includes a set of at least two support legs proximate the first trailer end.

7. The transforming trailer of claim 1, wherein the transforming trailer includes a set of wheels that make contact with the ground surface and located between the trailer body first and second ends.

8. The transforming trailer of claim 1, wherein the transforming trailer further includes a ramp lip on the first trailer end that may move from a retracted position, where the ramp lip is substantially parallel to the trailer body, to an extended position, where the ramp lip extends outward from the trailer body first end.

9. The transforming trailer of claim 8, wherein the transforming trailer further includes a ramp lip hydraulic cylinder located on the trailer body first end and in mechanical communication to the ramp lip,
wherein actuation of the ramp lip hydraulic cylinder may move the ramp lip from a retracted position to an extended position.

10. The transforming trailer of claim 1, wherein the foldable loading platform upper surfaces include a non-skid surface.

11. The transforming trailer of claim 1, wherein the second platform portion lower platform surface includes one or more wheels that make contact with the ground surface at some point during transforming of the trailer from a hauling position to a loading position.

12. The transforming trailer of claim 1, wherein the transforming trailer includes at least two platform hydraulic cylinders.

13. The transforming trailer of claim 1, wherein the platform hydraulic cylinder is connected to a recess of the trailer body.

14. A transforming trailer capable of being pulled by a standard pickup truck or van, the trailer comprising:
a trailer having a body defining a first trailer end and a second trailer end;
a leg proximate the first trailer end including:
an outer casing connected to the trailer body and extending downward;
a leg extension located within the outer casing;
a telescoping leg hydraulic cylinder located within the outer casing;
wherein actuation of telescoping leg hydraulic cylinder moves leg extension between an extended position, with the leg extension in contact with a ground surface, and a retracted position, with the leg extension above the ground surface; and
wherein movement of the leg extension into an extended position causes the trailer body to move into a loading position, with the first trailer end raised and the second trailer end lowered so that the trailer body slopes downwardly from the first trailer end to the second trailer end, and
wherein movement of the leg extension into a retracted position causes the trailer body to move into a hauling position, with the trailer body relatively parallel to the ground surface.

15. The transforming trailer of claim 14, wherein the trailer further includes a loading platform having a first end and a second end and connected proximate the trailer body second end,
wherein the loading platform is at an angled orientation relative to the trailer body and;
wherein loading platform second end makes contact with a ground surface when the transforming trailer is in a loading position.

16. The transforming trailer of claim 14, wherein the transforming trailer includes a set of wheels that make contact with the ground surface and are located between the trailer body first and second ends.

17. The transforming trailer of claim 14, wherein the transforming trailer further includes a ramp lip on the first trailer end that may move from a retracted position, where the ramp lip is substantially parallel to the trailer body, to an extended position, where the ramp lip extends outward from the trailer body first end.

18. A method for the transfer of baled material, the method comprising the steps of:
transporting a transforming trailer carrying a forklift using a standard pickup truck or van to the location of baled materials, the trailer comprising:
a trailer having a body defining a first trailer end and a second trailer end;
a leg proximate the first trailer end including:
an outer casing connected to the trailer body and extending downward;
a leg extension located within the outer casing;
a telescoping leg hydraulic cylinder located within the outer casing;
wherein actuation of telescoping leg hydraulic cylinder moves the leg extension between an extended position, with the leg extension in contact with a ground surface, and a retracted position, with the leg extension above the ground surface and within the outer casing; and
wherein movement of the leg extension into an extended position causes the trailer body to move into a loading position, with the first trailer end raised and the second trailer end lowered so that the trailer body slopes downwardly from the first trailer end to the second trailer end, and
wherein movement of the leg support into a retracted position causes the trailer body to move into a hauling position, with the trailer body relatively parallel to the ground surface;
using the forklift carried by the transforming trailer to move the baled material onto the body of the transforming trailer after transforming the transforming trailer into the loading position;
transporting the transforming trailer, the forklift and the baled material to the desired location after transforming the transforming trailer into the hauling position;
placing the baled material at a desired location using the forklift after transforming the trailer into the loading position.
